(19) United States
(12) Patent Application Publication
(10) Pub. No.: US 2008/0209910 A1
(43) Pub. Date: Sep. 4, 2008

(54) METHOD OF STARTING A GAS TURBINE HELICOPTER ENGINE, A FUEL FEED CIRCUIT FOR SUCH AN ENGINE, AND AN ENGINE HAVING SUCH A CIRCUIT

(75) Inventor: Hubert VERDIER, Nay (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Turbomeca, Bordes (FR)

(21) Appl. No.: 12/040,388

(22) Filed: Feb. 29, 2008

(30) Foreign Application Priority Data
Mar. 2, 2007 (FR) 07 53613

(51) Int. Cl. F02C 7/26; F02C 7/22

(52) U.S. Cl. 60/778; 60/746

(57) ABSTRACT

At least one of the main injectors of the engine, forming a starter main injector, is fed directly by the pressurized feed pipe, while a head loss is imposed between the pressurized feed pipe and the other main injectors. Ignition is caused to take place at the starter main injector, and after ignition, said head loss imposed between the feed pipe and the other main injectors is eliminated so that all of the main injectors are fed with fuel at substantially the same pressure, without any imposed head loss.

### BACKGROUND OF THE INVENTION

The invention relates to gas turbine helicopter engines, and in particular to feeding fuel to such engines, and to a method of starting them.

A known circuit that is commonly used for feeding fuel to the combustion chamber of a helicopter engine is shown diagrammatically in FIG. 1.

Fuel is taken from a tank (not shown) by means of a pump 10 that delivers the fuel under pressure in a feed pipe 12 having a metering valve 14 mounted therein for adjusting flow rate. The pipe 12 is connected via a rated retaining valve 16, or level valve, to a set of main injectors 20 that serve to inject an air and fuel mixture into the combustion chamber (represented by 22). The level valve 16 imposes a head loss, e.g. of 6 bars to 10 bars (0.6 megapascals (MPa) to 1 MPa), which is adjusted, for example, by means of a rating spring. At a location upstream of the level valve 16, the pipe 12 is also connected to one or more starter injectors 24, generally two in number, via an electrically controlled starter valve 18. A purge pipe 19 is also connected to the starter valve 18, which valve is controlled electrically to connect the starter injectors 24 to the feed pipe 12 or to the purge pipe 19.

In order to start the engine, the valve 18 is controlled to put the starter injectors 24 into connection with the feed pipe 12. Ignition is produced by an ignition spark plug 26 close to the injectors 24. The level valve guarantees that fuel is present at the injectors 24 at a pressure that is sufficient for starting, even at high altitude. After starting, feed to the starter injectors 24 is interrupted by the valve 18, which is controlled to put the injectors 24 into communication with the purge pipe, with feed to the combustion chamber being provided solely by the main injectors 20. It is necessary to purge the starter injectors in order to avoid fuel coking as would happen if they were not purged, which coking could harm subsequent proper operation of the starter injectors because of the solid deposits formed.

With such a fuel circuit, the head loss caused by the level valve 16 is of use solely for preserving a reserve of fuel pressure on starting and it gives rise to permanent extra pressure in the fuel feed pipe while the engine is in operation. Furthermore, starter injectors are provided in addition to main injectors, and it is necessary to provide means for purging the starter injectors.

### OBJECT AND SUMMARY OF THE INVENTION

The invention seeks to avoid the above-mentioned drawbacks, and in one of its aspects it provides a method of starting a gas turbine helicopter engine fed by a fuel circuit comprising a pipe for feeding fuel under pressure and a plurality of main injectors for injecting fuel into a combustion chamber of the engine, the method comprising:
feeding at least one of the main injectors that constitutes a starter main injector directly from the pressurized feed pipe, while imposing a head loss between the pressurized feed pipe and the other main injectors;
causing ignition to take place at the starter main injector; and
after ignition, eliminating said head loss imposed between the feed pipe and the other main injectors so that all of the main injectors are fed with fuel at substantially the same pressure, without any imposed head loss.

Since one of the main injectors is used as a starter injector, there is no need to provide specific starter injectors, and thus no need to provide means for purging them after starting. Furthermore, the level valve is active only while starting. In normal operation, no extra pressure is required in the feed pipe since there is no imposed head loss. Compared with the prior art fuel feed circuit, the output pressure from the pump can thus be lowered and/or a greater pressure can be made available to the main injectors for improving the spraying of fuel.

In an implementation of the method, the head loss is imposed by interposing a level valve between the pressurized feed pipe and the other main injectors, and the head loss is eliminated by closing an on/off valve in a pipe bypassing the level valve.

The invention also provides a fuel feed circuit for a combustion chamber of a gas turbine helicopter engine, the circuit comprising a plurality of main injectors for injecting fuel into a combustion chamber of the engine, and a pipe for feeding fuel under pressure, in which circuit:
at least one of the main injectors forming a starter main injector is connected directly to the pressurized feed pipe;
the other main injectors are connected to the pressurized feed pipe via a circuit comprising, in parallel, a level valve imposing a head loss and an on/off valve; and
a control circuit for the on/off valve is provided to select between the head loss that is imposed by the level valve being applied and being eliminated.

The invention also provides a gas turbine helicopter engine including a combustion chamber and a circuit for feeding fuel to the combustion chamber as defined above, in particular an engine with a combustion chamber having gyratory air flow. A gyratory flow of air in the combustion chamber encourages the propagation of the flame generated by the starter main injector to all of the other main injectors.

### BRIEF DESCRIPTION OF THE DRAWINGS

The invention can be better understood on reading the following description given by way of non-limiting indication and with reference to the accompanying drawings, in which:

FIG. 1, described above, is a diagrammatic view of a prior art fuel feed circuit for a gas turbine helicopter engine;

FIG. 2 is a diagrammatic view of an embodiment of a circuit in accordance with the invention for feeding fuel to a combustion chamber of a gas turbine helicopter engine;

FIG. 3 is a highly diagrammatic fragmentary view in axial half-section of a combustion chamber having gyratory air flow and suitable for being fed by a circuit such as that shown in FIG. 2; and

FIG. 4 is a fragmentary cross-section on a larger scale of the FIG. 3 combustion chamber.

### DETAILED DESCRIPTION OF AN EMBODIMENT OF THE INVENTION

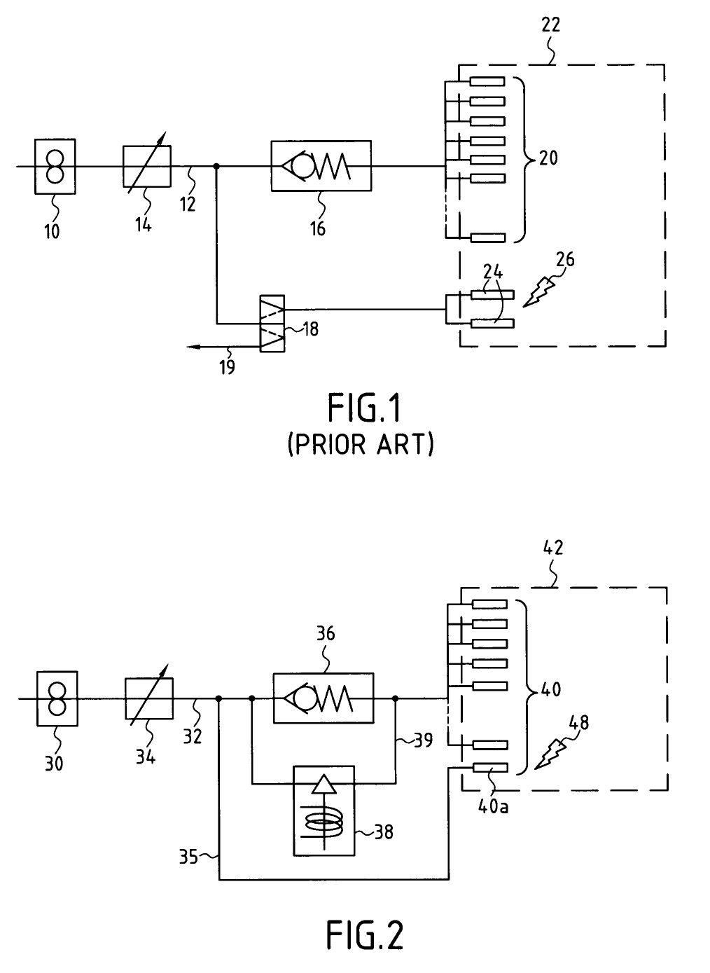

In the FIG. 2 fuel feed circuit, there can be seen, as in the circuit of FIG. 1, a pump 30 for taking fuel from a tank (not shown) to be delivered under pressure in a feed pipe 32 having a metering valve 34 mounted therein to control the fuel flow rate.

A plurality of main injectors 40 are mounted on a wall of a combustion chamber (represented by 42) to inject an air and fuel mixture into the combustion chamber. One 40a of the main injectors 40 is connected directly to the feed pipe 32 via a pipe 35. The other main injectors are connected to the feed pipe 32 via a circuit that comprises in parallel both a rated retaining valve or level valve 36, and an on/off valve 38 mounted in a pipe 39 bypassing the level valve 36, the pipe 35 being connected to the feed pipe 32 upstream from the level valve 36. The level valve 36 imposes a preadjusted head loss, e.g. of 6 bars to 10 bars (0.6 MPa to 1 MPa), e.g. by means of a rating spring. The on/off valve 38 may be electrically controlled, for example, having a closed position in which flow through the bypass pipe 39 is prevented, the level valve 36 then being active, and an open position in which flow through the bypass pipe 39 is allowed, the level valve 36 then being inactive.

The fuel feed circuit operates as follows.

On starting, the solenoid valve 38 is controlled to close the bypass pipe 39. The level valve 36 is active, so a high pressure feed is guaranteed to the starter main injector 40a. Ignition is caused by a starter spark plug 48 close to the injector 40a, and the flame propagates to the other main injectors that are fed with fuel at lower pressure because the retaining valve 36 is inserted.

After starting, the solenoid valve 38 is controlled to open the passage via the bypass pipe 39, thereby short-circuiting the level valve 36. All of the main injectors 40, including the starter main injector 40a, are fed at substantially the same fuel pressure.

In the example shown, only one main injector is used for starting. Nevertheless, it is possible to envisage using a plurality of main injectors for starting that are connected directly to the feed pipe 32 by the pipe 35, insofar as there remains sufficient pressure on starting to feed the other main injectors via the retaining valve 36, even when starting at high altitude.

It should be observed that the starter main injector 40a is similar to the other main injectors, unlike known injectors having both a pilot circuit that is used for starting and a main circuit.

Propagation of the flame generated at the starter main injector to the other main injectors is facilitated when the combustion chamber 42 is a chamber having a gyratory flow of air.

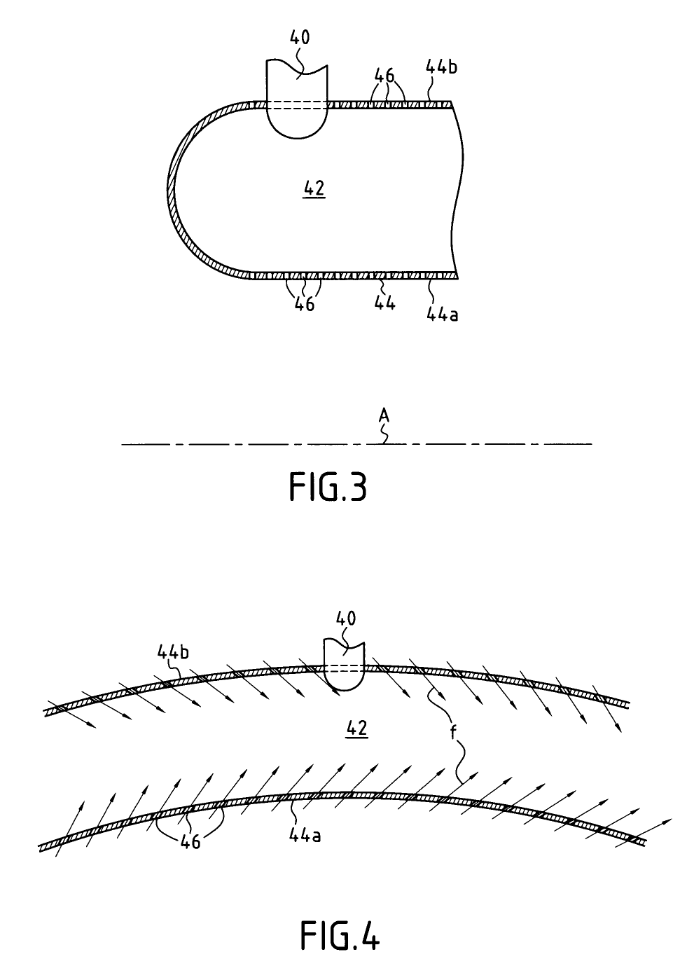

FIG. 3 shows very diagrammatically an annular combustion chamber with gyratory air flow, having an inner wall 44a and an outer wall 44b with multiple perforations. The injectors 40 are carried by the wall 44b.

As can be seen in FIG. 4, the perforations 46 formed in the walls 44a, 44b are inclined relative to the normal to said walls. The air introduced into the chamber 42 via the perforations 46, as represented by arrows f in FIG. 4, generates a gyratory flow around the axis A of the chamber 42.

What is claimed is:

1. A method of starting a gas turbine helicopter engine fed by a fuel circuit comprising a pipe for feeding fuel under pressure and a plurality of main injectors for injecting fuel into a combustion chamber of the engine, the method comprising:
feeding at least one of the main injectors that constitutes a starter main injector directly from the pressurized feed pipe, while imposing a head loss between the pressurized feed pipe and the other main injectors;
causing ignition to take place at the starter main injector; and
after ignition, eliminating said head loss imposed between the feed pipe and the other main injectors so that all of the main injectors are fed with fuel at substantially the same pressure, without any imposed head loss.

2. A method as claimed in claim 1, in which the head loss is imposed by interposing a level valve between the pressurized feed pipe and the other main injectors, and the head loss is eliminated by closing an on/off valve in a pipe bypassing the level valve.

3. A fuel feed circuit for a combustion chamber of a gas turbine helicopter engine, the circuit comprising a plurality of main injectors for injecting fuel into a combustion chamber of the engine, and a pipe for feeding fuel under pressure, in which circuit:
at least one of the main injectors forming a starter main injector is connected directly to the pressurized feed pipe;
the other main injectors are connected to the pressurized feed pipe via a circuit comprising, in parallel, a level valve imposing a head loss and an on/off valve; and
a control circuit for the on/off valve is provided to select between the head loss that is imposed by the level valve being applied and being eliminated.

4. A gas turbine helicopter engine having a combustion chamber and a fuel feed circuit for the combustion chamber in accordance with claim 3.

5. An engine as claimed in claim 4, in which the combustion chamber is a gyratory air flow combustion chamber.
